(19) United States
(12) Patent Application Publication
(10) Pub. No.: US 2006/0044399 A1
(43) Pub. Date: Mar. 2, 2006

(54) Control system for an image capture device

(75) Inventors: John R. Fredlund, Rochester, NY (US); John C. Neel, Pittsford, NY (US); Wilbert F. Janson JR., Shortsville, NY (US); Dan Harel, Rochester, NY (US); Laura R. Whitby, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/931,658

(22) Filed: Sep. 1, 2004

(51) Int. Cl. H04N 5/225

(52) U.S. Cl. 348/207.99; 348/222.1

(57) ABSTRACT

Imaging systems and methods for operating an imaging system capable of forming images based upon adjustable image capture settings and a viewing frame in which evaluation images of a scene are observable are provided. In accordance with the method, an initial viewing distance is detected from the viewing frame to an anatomical feature of a user; determining an initial image capture setting. A change in the viewing distance is detected and a revised image capture setting is determined based upon an extent of the change in the change in the viewing distance. The image capture setting is adjusted based upon the revised image capture setting.

### FIELD OF THE INVENTION

The invention relates to user interface systems for use in an imaging device.

### BACKGROUND OF THE INVENTION

In a conventional film and/or digital camera a photographer views an image of a scene to be captured by observing the scene through an optical viewfinder. The viewfinder focuses light from a portion of the scene on the eye of the photographer, to define an area of the scene that will be included in an image that will be captured based upon current camera settings. Traditionally, cameras are held in a fixed position relative to a photographer's eyes during image composition and capture so that the photographer can view the focused light that is provided by the viewfinder.

Recently, hybrid film/digital cameras, digital cameras and video cameras have begun to incorporate electronic displays that are operable in a mode that allows such cameras to present a “virtual viewfinder” which captures images electronically during composition and presents to the photographer a stream of the captured images on an electronic display. When the virtual viewfinder shows an image of the scene that is pleasing to the photographer, the photographer can cause an image of the scene to be stored. While some of the displays that are used for virtual viewfinder purposes are incorporated into a camera like a conventional optical viewfinder, it is more common to find that cameras present the virtual viewfinder images on a display that is external to a camera. When, an external display is used as a virtual viewfinder, a photographer must typically position the camera at a distance from the face of the photographer so that the photographer can see what is being displayed.

It will be appreciated that, while a camera is so positioned it can be challenging for the photographer to operate camera controls while also watching the virtual viewfinder. Thus, what is needed in the art is a camera that allows a photographer to compose an image in the virtual viewfinder mode of operation without requiring that the photographer operate a plurality of controls. Of particular interest in the art is the ability of a photographer to rapidly and intuitively adjust the field of view of the image capture system of such a camera such as by adjusting the zoom settings without requiring the photographer to make adjustments using manual controls.

It will further be appreciated that as hybrid, digital, and video cameras become smaller, there is a general desire in the art of camera design to reduce the number of manual controls that are required to operate the camera as each manual control on the camera requires at least a minimum amount of camera space in which to operate. Accordingly, there is a need for cameras that provide user controls such as a user controlled zooming capability, but that do so without requiring independent controllers zoom and/or aspect ratio adjustment.

One approach to meeting this need is to combine multiple camera functions into a single camera controller, as described in U.S. Pat. No. 5,970,261, entitled “Zoom Camera, Mode Set Up Device And Control Method For Zoom Camera”, filed by Ishiguro et al. on Sep. 11, 1997. However, this approach is confusing for novice users and still requires users to make zoom adjustments using a manual controller.

In the art of controlling display devices, it is known to monitor the movement of people and things within a space so that control inputs can be made in response to sensed movement. U.S. patent Publication No. 2003/0210255 entitled “Image Display Processing Apparatus, Image Display Processing Method and Computer Program” filed by Hiraki on Mar. 13, 2003, describes an image display processing method and program that determines what is to be displayed on an image based upon the three dimensional movement of a controller. This system allows a user to scroll about in an image to be presented on a display by moving the controller. Gesture based methods for controlling an image display are also known. For example, the EyeToy camera and PlayStation video game console sold by Sony Computer Entertainment America Inc. (SCEA), San Mateo, Calif., USA allows a user to control action in a video game based upon body movements of the user.

Such techniques are not well suited for use during an image capture operation as the gesticulating and movements required thereby can interfere with the scene image being captured, can interfere with the physical ability of the photographer to capture an image and can consume substantial amounts of electrical power and processing power necessary to operate the camera.

What is needed in the art therefore is a camera control system and method for operating a camera such as a digital camera that allows a user to execute control inputs to a camera such as selecting a zoom setting and/or an aspect ratio in a more intuitive manner.

### SUMMARY OF THE INVENTION

In one aspect of the invention, a method is provided for operating an imaging system capable of forming images based upon adjustable image capture settings and a viewing frame in which evaluation images of a scene are observable. In accordance with the method, an initial viewing distance is detected from the viewing frame evaluation image of a scene to an anatomical feature of the user; and an initial image capture setting is determined.

A change is detected in the viewing distance, and a revised image capture setting is determined based upon the initial image capture setting and an extent of the change in the viewing distance. The image capture setting is adjusted based upon the revised image capture setting.

In another aspect of the invention, a method is provided for operating an image capture system having an image capture device. In accordance with this method, a field of view in a scene is determined based upon a portion of a scene that is observable by a user who views the scene using a viewing frame that is positioned separately from the image capture device and at least one image capture setting is determined based upon the determined field of view; and capturing an image of the scene using the determined image capture setting and providing an image of the field of view.

In still another aspect of the invention, an image capture device is provided. The image capture device has:

an image capture system adapted to receive light and to form an image based upon the received light and a viewing frame allowing a user of the image capture system to view an image of the scene and to define a field of view in the scene based upon what the user views using the viewing frame and a sensor system sampling a viewing area behind the viewing frame and providing a positioning signal indicative of a distance from the viewing frame to a part of the user's body; and

a controller adapted to determine an image capture setting based upon the positioning signal, to cause an image of the scene to be captured and to cause an output image to be generated that is based upon the determined setting.

In still another aspect of the invention, an image capture device is provided. The image capture system has:

an image capture device adapted to receive light and to form an image based upon the received light, a viewing frame defining a framing area through which a user views a portion of the scene, and a viewing frame position determining circuit adapted to detect the position of the viewing frame.

An eye position determining circuit is adapted to detect the position of an eye.

A controller is adapted to a provide an image based upon an image captured by the image capture system, the position of the viewing frame and the position of an eye of the user, so that the image corresponds to the portion of the scene that is within the field of view as observed by the eye of the user.

In yet another embodiment, an image capture device is provided.

The image capture device has a body having an image capture means for capturing an image of a scene in accordance with at least one image capture setting.

A viewing frame is provided for allowing a user to observe a sequence of images depicting a portion of a scene during image composition.

Means are provided for determining a viewing distance from the viewing frame to the user, and for determining at least one image capture setting based upon any detected change in the viewing distance during image composition.

A setting means is provided for setting the image capture system in accordance with the determined image capture setting.

### BRIEF DESCRIPTION OF THE DRAWINGS

FIG. 1 shows a block diagram of one embodiment of an image capture device according to the invention;

FIG. 2 shows a back, elevation view of the image capture device of FIG. 1;

FIG. 4A shows a user holding a viewing frame at an initial viewing distance;

FIG. 4B shows an example initial evaluation image obtained by the image capture device when the viewing frame is device is held at the initial viewing distance;

FIG. 5A shows a user holding a viewing frame at an increased viewing distance;

FIG. 5B shows an example evaluation image obtained by the image capture device when the viewing frame device is held at the increased viewing distance;

FIG. 6A shows a user holding a viewing frame at a decreased viewing distance;

FIG. 6B shows an example evaluation image obtained by the image capture device when the viewing frame device is held at the decreased viewing distance;

FIGS. 7A, 7B, 8A, 8B, 9A, and 9B illustrate one way in which a zoom setting for an image capture device can be determined based upon a detected change in viewing distance;

FIG. 10 illustrates the process of determining field of view for use in capturing an image;

FIG. 11 is a flow diagram of the method for capturing an image that corresponds to the field of view that a user sees through a transmissive type viewing frame;

FIG. 12 illustrates the process for determination of a field of view for use in capturing an image;

FIG. 13 illustrates initial evaluation image of a scene containing elements at macro, near, far, and infinity positions;

FIG. 14A-14C illustrates another example embodiment of one form of image capture system of the invention; and

FIG. 15 shows another embodiment of the invention within image capture system comprising a digital camera taking the form of a ring.

### DETAILED DESCRIPTION OF THE INVENTION

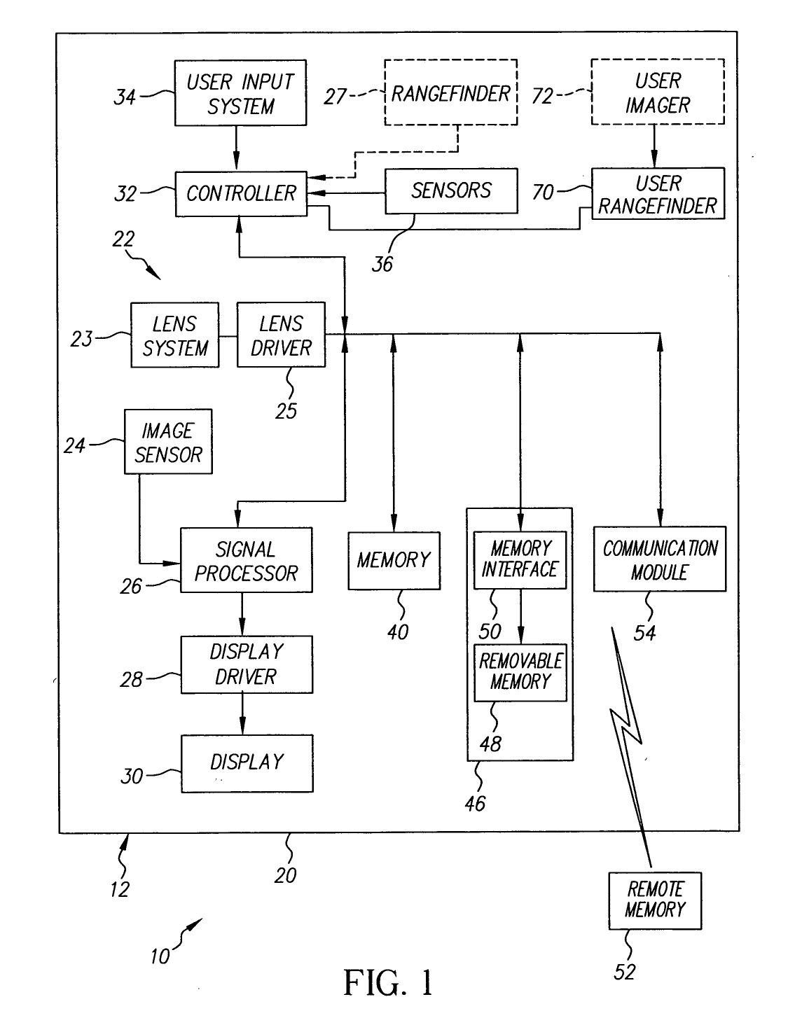

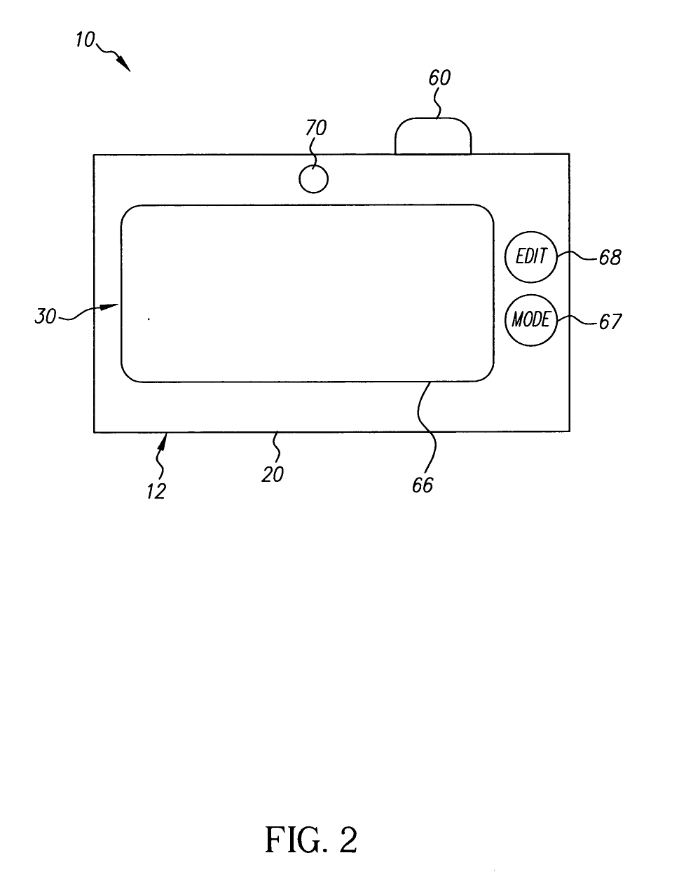

FIG. 1 shows a block diagram of an embodiment of an image capture system 10. FIG. 2 shows a back, elevation view of the image capture system 10 of FIG. 1. As is shown in FIGS. 1 and 2, image capture system 10 takes the form of a digital camera 12 comprising a body 20 containing an image capture system 22 having a lens system 23, an image sensor 24, a signal processor 26, an optional display driver 28 and a display 30. In operation, light from a scene is focused by lens system 23 to form an image on image sensor 24. Lens system 23 can have one or more elements.

Lens system 23 can be of a fixed focus type or can be manually or automatically adjustable. In the embodiment shown in FIG. 1, lens system 23 is automatically adjusted. Lens system 23 can be simple, such as having a single focal length with manual focusing or a fixed focus. In the example embodiment shown in FIG. 1, taking lens unit 22 is a motorized 6× zoom lens unit in which a mobile element or elements (not shown) are driven, relative to a stationary element or elements (not shown) by lens driver 25. Lens driver 25 controls both the lens focal length and the lens focus position of lens system 23 and sets a lens focal length and/or position based upon signals from signal processor 26, an optional automatic range finder system 27, and/or controller 32.

The focus position of lens system 23 can be automatically selected using a variety of known strategies. For example, in one embodiment, image sensor 24 is used to provide multi-spot autofocus using what is called the “through focus” or “whole way scanning” approach. In such an approach the scene is divided into a grid of regions or spots, and the optimum focus distance is determined for each image region. The optimum focus distance for each region is determined by moving lens system 23 through a range of focus distance positions, from the near focus distance to the infinity position, while capturing images. Depending on the design of digital camera 12, between four and thirty-two images may need to be captured at different focus distances. Typically, capturing images at eight different distances provides suitable accuracy.

The captured image data is then analyzed to determine the optimum focus distance for each image region. This analysis begins by band-pass filtering the sensor signal using one or more filters, as described in commonly assigned U.S. Pat. No. 5,874,994 “Filter Employing Arithmetic Operations for an Electronic Synchronized Digital Camera” filed by Xie et al. on Dec. 11, 1995, the disclosure of which is herein incorporated by reference. The absolute value of the bandpass filter output for each image region is then peak detected, in order to determine a focus value for that image region, at that focus distance. After the focus values for each image region are determined for each captured focus distance position, the optimum focus distances for each image region can be determined by selecting the captured focus distance that provides the maximum focus value, or by estimating an intermediate distance value, between the two measured captured focus distances which provided the two largest focus values, using various interpolation techniques.

The lens focus distance to be used to capture a digital image can now be determined. In a preferred embodiment, the image regions corresponding to a target object (e.g. a person being photographed) are determined. The focus position is then set to provide the best focus for these image regions. For example, an image of a scene can be divided into a plurality of sub-divisions. A focus evaluation value representative of the high frequency component contained in each subdivision of the image can be determined and the focus evaluation values can be used to determine object distances as described in commonly assigned U.S. Pat. No. 5,877,809 entitled “Method Of Automatic Object Detection In An Image”, filed by Omata et al. on Oct. 15, 1996, the disclosure of which is herein incorporated by reference. If the target object is moving, object tracking may be performed, as described in commonly assigned U.S. Pat. No. 6,067,114 entitled “Detecting Compositional Change in Image” filed by Omata et al. on Oct. 26, 1996, the disclosure of which is herein incorporated by reference. In an alternative embodiment, the focus values determined by “whole way scanning” are used to set a rough focus position, which is refined using a fine focus mode, as described in commonly assigned U.S. Pat. No. 5,715,483, entitled “Automatic Focusing Apparatus and Method”, filed by Omata et al. on Oct. 11, 1998, the disclosure of which is herein incorporated by reference.

In one embodiment, bandpass filtering and other calculations used to provide auto-focus information for digital camera 12 are performed by digital signal processor 26. In this embodiment, digital camera 12 uses a specially adapted image sensor 24, as is shown in commonly assigned U.S. Pat. No 5,668,597 entitled “An Electronic Camera With Rapid Automatic Focus Of An Image Upon A Progressive Scan Image Sensor”, filed by Parulski et al. on Dec. 30, 1994, the disclosure of which is herein incorporated by reference, to automatically set the lens focus position. As described in the '597 patent, only some of the lines of sensor photoelements (e.g. only ¼ of the lines) are used to determine the focus. The other lines are eliminated during the sensor readout process. This reduces the sensor readout time, thus shortening the time required to focus lens system 23.

In an alternative embodiment, digital camera 12 uses a separate optical or other type (e.g. ultrasonic) of rangefinder 27 to identify the subject of the image and to select a focus position for lens system 23 that is appropriate for the distance to the subject. Rangefinder 27 can operate lens driver 25, directly or as shown in FIG. 1, can provide signals to signal processor 26 or controller 32 from which signal processor 26 or controller 32 can generate signals that are to be used for image capture. A wide variety of suitable multiple sensor rangefinders 27 known to those of skill in the art are suitable for use. For example, U.S. Pat. No. 5,440,369 entitled “Compact Camera With Automatic Focal Length Dependent Exposure Adjustments” filed by Tabata et al. on Nov. 30, 1993, the disclosure of which is herein incorporated by reference, discloses one such rangefinder 27. The focus determination provided by rangefinder 27 can be of the single-spot or multi-spot type. Preferably, the focus determination uses multiple spots. In multi-spot focus determination, the scene is divided into a grid of areas or spots, and the optimum focus distance is determined for each spot. One of the spots is identified as the subject of the image and the focus distance for that spot is used to set the focus of lens system 23.

A feedback loop is established between lens driver 25 and camera controller 32 so that camera controller 32 can accurately set the focus position of lens system 23.

Lens system 23 is also optionally adjustable to provide a variable zoom. In the embodiment shown lens driver 25 automatically adjusts the position of one or more mobile elements (not shown) relative to one or more stationary elements (not shown) of lens system 23 based upon signals from signal processor 26, an automatic range finder system 27, and/or controller 32 to provide a zoom magnification. Lens system 23 can be of a fixed magnification, manually adjustable and/or can employ other known arrangements for providing an adjustable zoom.

Light from the scene that is focused by lens system 23 onto image sensor 24 is converted into image signals representing an image of the scene. Image sensor 24 can comprise a charge couple device (CCD), a complimentary metal oxide sensor (CMOS), or any other electronic image sensor known to those of ordinary skill in the art. The image signals can be in digital or analog form.

Signal processor 26 receives image signals from image sensor 24 and transforms the image signals into an image in the form of digital data. The digital image can comprise one or more still images, multiple still images and/or a stream of apparently moving images such as a video segment. Where the digital image data comprises a stream of apparently moving images, the digital image data can comprise image data stored in an interleaved or interlaced image form, a sequence of still images, and/or other forms known to those of skill in the art of digital video.

Signal processor 26 can apply various image processing algorithms to the image signals when forming a digital image. These can include but are not limited to color and exposure balancing, interpolation and compression. Where the image signals are in the form of analog signals, signal processor 26 also converts these analog signals into a digital form. In certain embodiments of the invention, signal processor 26 can be adapted to process image signal so that the digital image formed thereby appears to have been captured at a different zoom setting than that actually provided by the optical lens system. This can be done by using a subset of the image signals from image sensor 24 and interpolating the subset of the image signals to form the digital image. This is known generally in the art as “digital zoom”. Such digital zoom can be used to provide electronically controllable zoom adjusted in fixed focus, manual focus, and even automatically adjustable focus systems.

Controller 32 controls the operation of the image capture system 10 during imaging operations, including but not limited to image capture system 22, display 30 and memory such as memory 40. Controller 32 causes image sensor 24, signal processor 26, display 30 and memory 40 to capture, present and store original images in response to signals received from a user input system 34, data from signal processor 26 and data received from optional sensors 36. Controller 32 can comprise a microprocessor such as a programmable general purpose microprocessor, a dedicated micro-processor or micro-controller, a combination of discrete components or any other system that can be used to control operation of image capture system 10.

Controller 32 cooperates with a user input system 34 to allow image capture system 10 to interact with a user. User input system 34 can comprise any form of transducer or other device capable of receiving an input from a user and converting this input into a form that can be used by controller 32 in operating image capture system 10. For example, user input system 34 can comprise a touch screen input, a touch pad input, a 4-way switch, a 6-way switch, an 8-way switch, a stylus system, a trackball system, a joystick system, a voice recognition system, a gesture recognition system or other such systems. In the digital camera 12 embodiment of image capture system 10 shown in FIGS. 1 and 2 user input system 34 includes a trigger button 60 that sends a trigger signal to controller 32 indicating a desire to capture an image. User input system 34 can also include other buttons including the mode select button 64, and the edit button 68 shown in FIG. 2, the function of which will be described in greater detail below.

Sensors 36 are optional and can include light sensors and other sensors known in the art that can be used to detect conditions in the environment surrounding image capture system 10 and to convert this information into a form that can be used by controller 32 in governing operation of image capture system 10. Sensors 36 can include audio sensors adapted to capture sounds. Such audio sensors can be of conventional design or can be capable of providing controllably focused audio capture such as the audio zoom system described in U.S. Pat. No. 4,862,278, entitled “Video Camera Microphone with Zoom Variable Acoustic Focus”, filed by Dann et al. on Oct. 14, 1986. Sensors 36 can also include biometric sensors adapted to detect characteristics of a user for security and affective imaging purposes. Where a need for illumination is determined, controller 32 can cause a scene illumination system 37 such as a light, strobe, or flash system to emit light.

Controller 32 causes an image signal and corresponding digital image to be formed when a trigger condition is detected. Typically, the trigger condition occurs when a user depresses shutter trigger button 60, however, controller 32 can determine that a trigger condition exists at a particular time, or at a particular time after shutter trigger button 60 is depressed. Alternatively, controller 32 can determine that a trigger condition exists when optional sensors 36 detect certain environmental conditions, such as optical or radio frequency signals. Further controller 32 can determine that a trigger condition exists based upon affective signals obtained from the physiology of a user.

Controller 32 can also be used to generate metadata in association with each image. Metadata is data that is related to a digital image or a portion of a digital image but that is not necessarily observable in the image itself. In this regard, controller 32 can receive signals from signal processor 26, camera user input system 34 and other sensors 36 and, optionally, generates metadata based upon such signals. The metadata can include but is not limited to information such as the time, date and location that the original image was captured, the type of image sensor 24, mode setting information, integration time information, taking lens unit setting information that characterizes the process used to capture the original image and processes, methods and algorithms used by image capture system 10 to form the original image. The metadata can also include but is not limited to any other information determined by controller 32 or stored in any memory in image capture system 10 such as information that identifies image capture system 10, and/or instructions for rendering or otherwise processing the digital image with which the metadata is associated. The metadata can also comprise an instruction to incorporate a particular message into digital image when presented. Such a message can be a text message to be rendered when the digital image is presented or rendered. The metadata can also include audio signals. The metadata can further include digital image data. In one embodiment of the invention, where digital zoom is used to form the image from a subset of the captured image, the metadata can include image data from portions of an image that are not incorporated into the subset of the digital image that is used to form the digital image. The metadata can also include any other information entered into image capture system 10.

The digital images and optional metadata, can be stored in a compressed form. For example where the digital image comprises a sequence of still images, the still images can be stored in a compressed form such as by using the JPEG (Joint Photographic Experts Group) ISO 10918-1 (ITU-T.81) standard. This JPEG compressed image data is stored using the so-called “Exif” image format defined in the Exchangeable Image File Format version 2.2 published by the Japan Electronics and Information Technology Industries Association JEITA CP-3451. Similarly, other compression systems such as the MPEG-4 (Motion Pictures Export Group) or Apple QuickTime™ standard can be used to store digital image data in a video form. Other image compression and storage forms can be used.

The digital images and metadata can be stored in a memory such as memory 40. Memory 40 can include conventional memory devices including solid state, magnetic, optical or other data storage devices. Memory 40 can be fixed within image capture system 10 or it can be removable. In the embodiment of FIG. 1, image capture system 10 is shown having a memory card slot 46 that holds a removable memory 48 such as a removable memory card and has a removable memory interface 50 for communicating with removable memory 48. The digital images and metadata can also be stored in a remote memory system 52 that is external to image capture system 10 such as a personal computer, computer network or other imaging system.

In the embodiment shown in FIGS. 1 and 2, image capture system 10 has a communication module 54 for communicating with remote memory system 52. The communication module 54 can be for example, an optical, radio frequency or other transducer that converts image and other data into a form that can be conveyed to the remote display device by way of an optical signal, radio frequency signal or other form of signal. Communication module 54 can also be used to receive a digital image and other information from a host computer or network (not shown). Controller 32 can also receive information and instructions from signals received by communication module 54 including but not limited to, signals from a remote control device (not shown) such as a remote trigger button (not shown) and can operate image capture system 10 in accordance with such signals.

Signal processor 26 and/or controller 32 also use image signals or the digital images to form evaluation images which have an appearance that corresponds to original images stored in image capture system 10 and are adapted for presentation on display 30. This allows users of image capture system 10 to use a display such as display 30 to view images that correspond to original images that are available in image capture system 10. Such images can include, for example images that have been captured by image capture system 22, and/or that were otherwise obtained such as by way of communication module 54 and stored in a memory such as memory 40 or removable memory 48.

Display 30 can comprise, for example, a color liquid crystal display (LCD), organic light emitting display (OLED) also known as an organic electro-luminescent display (OELD) or other type of video display. Display 30 can be external as is shown in FIG. 2, or it can be internal for example used in a viewfinder system 38. Alternatively, image capture system 10 can have more than one display 30 with, for example, one being external and one internal.

Signal processor 26 and/or controller 32 can also cooperate to generate other images such as text, graphics, icons and other information for presentation on display 30 that can allow interactive communication between controller 32 and a user of image capture system 10, with display 30 providing information to the user of image capture system 10 and the user of image capture system 10 using user input system 34 to interactively provide information to image capture system 10. Image capture system 10 can also have other displays such as a segmented LCD or LED display (not shown) which can also permit signal processor 26 and/or controller 32 to provide information to user 10. This capability is used for a variety of purposes such as establishing modes of operation, entering control settings, user preferences, and providing warnings and instructions to a user of image capture system 10. Other systems such as known systems and actuators for generating audio signals, vibrations, haptic feedback and other forms of signals can also be incorporated into image capture system 10 for use in providing information, feedback and warnings to the user of image capture system 10.

Typically, display 30 has less imaging resolution than image sensor 24. Accordingly, signal processor 26 reduces the resolution of image signal or digital image when forming evaluation images adapted for presentation on display 30. Down sampling and other conventional techniques for reducing the overall imaging resolution can be used. For example, resampling techniques such as are described in commonly assigned U.S. Pat. No. 5,164,831 “Electronic Still Camera Providing Multi-Format Storage Of Full And Reduced Resolution Images” filed by Kuchta et al. on March 15, 1990, can be used. The evaluation images can optionally be stored in a memory such as memory 40. The evaluation images can be adapted to be provided to an optional display driver 28 that can be used to drive display 30. Alternatively, the evaluation images can be converted into signals that can be transmitted by signal processor 26 in a form that directly causes display 30 to present the evaluation images. Where this is done, display driver 28 can be omitted.

Image capture system 10 can obtain original images for processing in a variety of ways. For example, in a digital camera embodiment, image capture system 10 can capture an original image using an image capture system 22 as described above. Imaging operations that can be used to obtain an original image using image capture system 22 include a capture process and can optionally also include a composition process and a verification process.

During the composition process, controller 32 provides an electronic viewfinder effect on display 30. In this regard, controller 32 causes signal processor 26 to cooperate with image sensor 24 to capture preview digital images during composition and to present a corresponding evaluation images on display 30.

In the embodiment shown in FIGS. 1 and 2, controller 32 enters the image composition process when shutter trigger button 60 is moved to a half depression position. However, other methods for determining when to enter a composition process can be used. For example, one of user input system 34, for example, the edit button 68 shown in FIG. 2 can be depressed by a user of image capture system 10, and can be interpreted by controller 32 as an instruction to enter the composition process. The evaluation images presented during composition can help a user to compose the scene for the capture of an original image.

The capture process is executed in response to controller 32 determining that a trigger condition exists. In the embodiment of FIGS. 1 and 2, a trigger signal is generated when trigger button 60 is moved to a full depression condition and controller 32 determines that a trigger condition exists when controller 32 detects the trigger signal. During the capture process, controller 32 sends a capture signal causing signal processor 26 to obtain image signals from image sensor 24 and to process the image signals to form digital image data comprising an original digital image.

During the verification process, an evaluation image corresponding to the original digital image is optionally formed for presentation on display 30 by signal processor 26 based upon the image signal. In one alternative embodiment, signal processor 26 converts each image signal into a digital image and then derives the corresponding evaluation image from the original digital image. The corresponding evaluation image is supplied to display 30 and is presented for a period of time. This permits a user to verify that the digital image has a preferred appearance.

Original images can also be obtained by image capture system 10 in ways other than image capture. For example, original images can by conveyed to image capture system 10 when such images are recorded on a removable memory that is operatively associated with memory interface 50. Alternatively, original images can be received by way of communication module 54. For example, where communication module 54 is adapted to communicate by way of a cellular telephone network, communication module 54 can be associated with a cellular telephone number or other identifying number that for example another user of the cellular telephone network such as the user of a telephone equipped with a digital camera can use to establish a communication link with image capture system 10 and transmit images which can be received by communication module 54. Accordingly, there are a variety of ways in which image capture system 10 can receive images and therefore, in certain embodiments of the present invention, it is not essential that image capture system 10 have an image capture system so long as other means such as those described above are available for importing images into image capture system 10.

FIG. 3 shows a first embodiment of a method for operating an imaging capture system 10 in accordance with the present invention. In this embodiment, image capture system 10 comprises an embodiment of digital camera 12 shown in FIGS. 1 and 2, that is adapted to set a zoom position of an adjustable zoom or to determine a digital zoom setting based upon a detected distance from a user of camera 12 to display 30 on camera 12. In accordance with this embodiment of the method of the invention, a user 6 causes camera 12 to enter a composition mode (step 80). This can be done as described above for example by depressing trigger button 60 to a half-depression position. This causes an initial evaluation image to be captured and presented on display 30 as is described above (step 82). A user 6 of digital camera 12 uses the initial evaluation image and subsequently presented evaluation images to compose an image to be captured of a scene.

An initial viewing distance between a viewing frame and user through which user 6 observes an image is then determined (step 84). The initial viewing distance is a relative measure of the degree of separation between a selected body feature of user 6 such as a head, face, neck or chest and the viewing frame. In the embodiment illustrated in FIGS. 1-6, the viewing frame is an image generating type of viewing frame 66 comprising display 30 of camera 12. Thus in this embodiment, the initial viewing distance is determined based upon the relative distance between display 30 and the selected body feature of user 6 at or about the time that camera 12 enters a composition mode. In other embodiments, the initial viewing distance can be determined in other ways such as being based upon a predicted initial viewing distance.

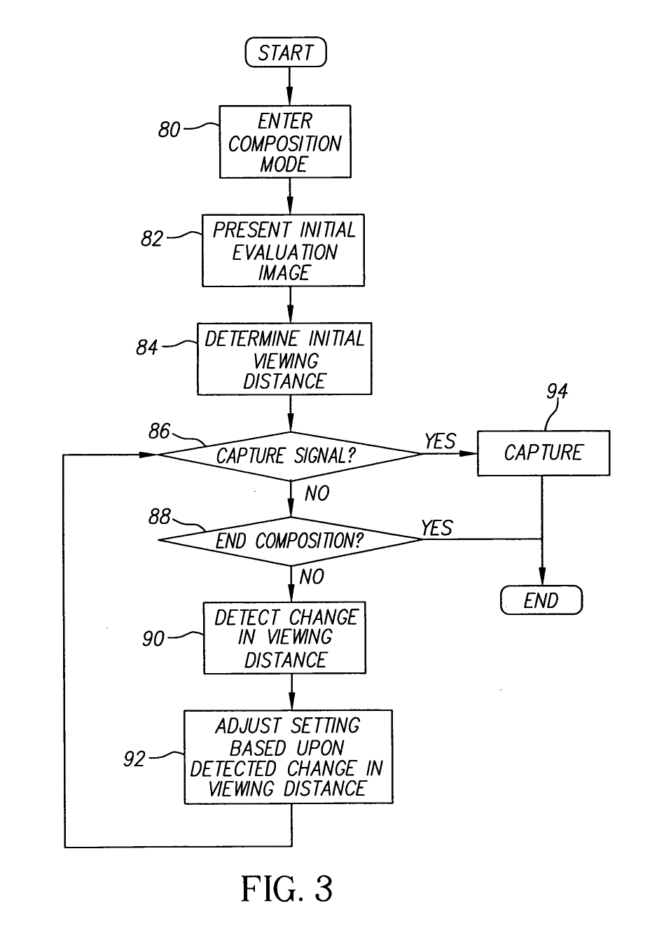

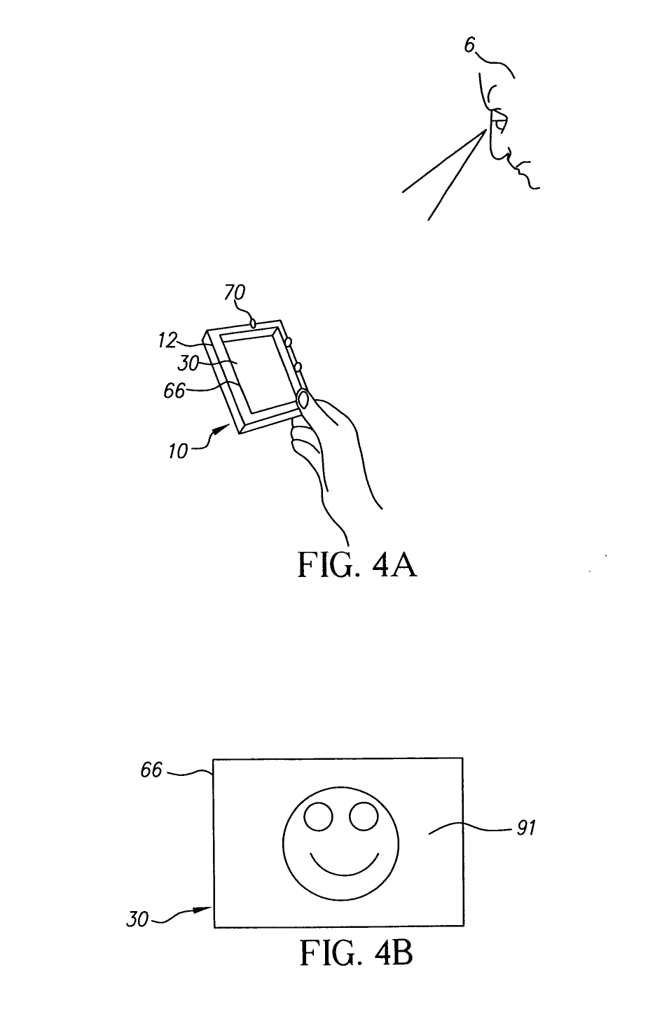

The measurement of the initial viewing distance is determined using a user rangefinder 70. As is seen in FIG. 2, user rangefinder 70 is positioned proximate to display 30. As shown in FIG. 4A, user rangefinder 70 is adapted to monitor at least a portion of a presentation space within which images presented by display 30 are viewable. User rangefinder 70 measures the viewing distance by detecting the distance from user rangefinder 70 to a particular object in the presentation space. User rangefinder 70 can determine the viewing distance from display 30 to user 6 by means infrared triangulation or other well-known distance determining circuits and systems of the type used, including but not limited to, auto-focus range finding circuits and systems that are described above for use in making auto-focus determinations during image capture operations. As noted above, user rangefinder 70 is typically activated when a predetermined condition is satisfied, such as a light touch on trigger button 60.

In still another embodiment, user rangefinder 70 can comprise an optional user imager 72 that is adapted to capture images of the presentation space for display 30 and that can provide these images to controller 32 and/or signal processor 26 so that viewing distance of user 6 relative to display 30 can be determined by analysis of these images. Additionally, the degree of separation may be determined by the dimensions of a particular feature such as separation between the eyes of user 6.

After an initial viewing distance is determined, the initial viewing distance is associated with an initial image capture setting. Typically, the initial setting is an image capture setting that is used to obtain the initial evaluation image. For example, the initial setting can comprise a zoom setting that helps to define the initial field of view of an initial evaluation image 96 shown in FIG. 4B that is initially presented by display 30 as camera 12 enters the composition mode.

In the embodiment shown in FIG. 3, if user 6 does not exit from the composition mode by causing an image to be captured, such as by depressing the capture button 60 (step 86) or by otherwise exiting from the composition mode (step 88), then controller 32 continues to monitor signals from user rangefinder 70 to detect any meaningful change in the viewing distance. Where such a change in the viewing distance is detected (step 90), controller 32 adjusts a setting of image capture system 10 (step 92) and the process returns to step 86. When controller 32 detects a capture signal (step 86) and image can be captured using the determined image capture setting.

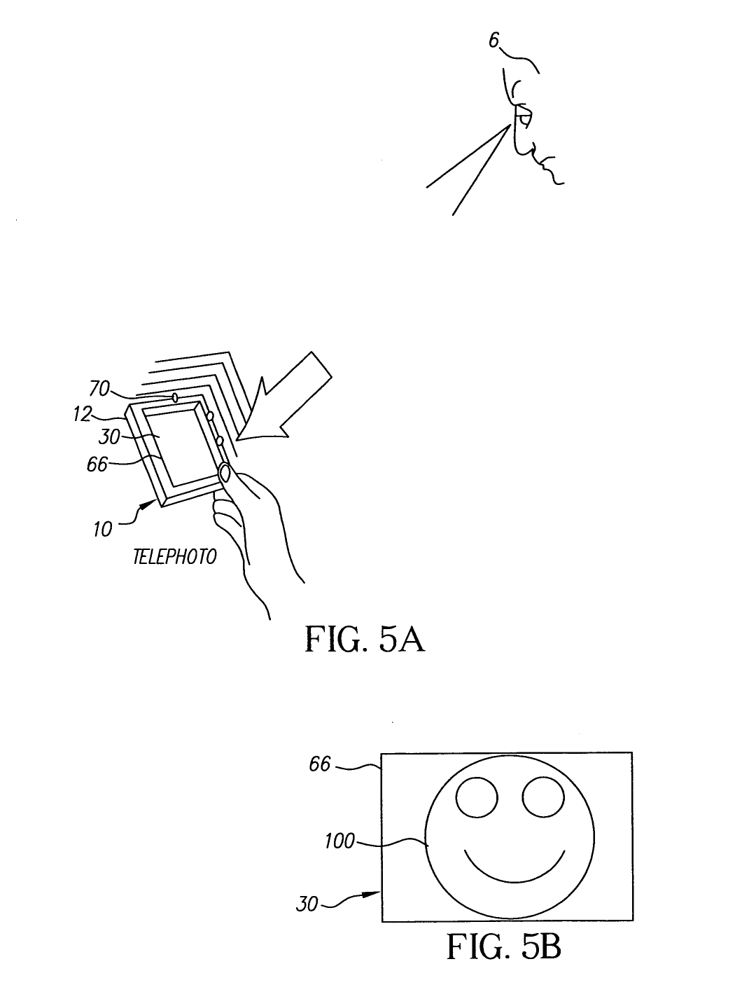

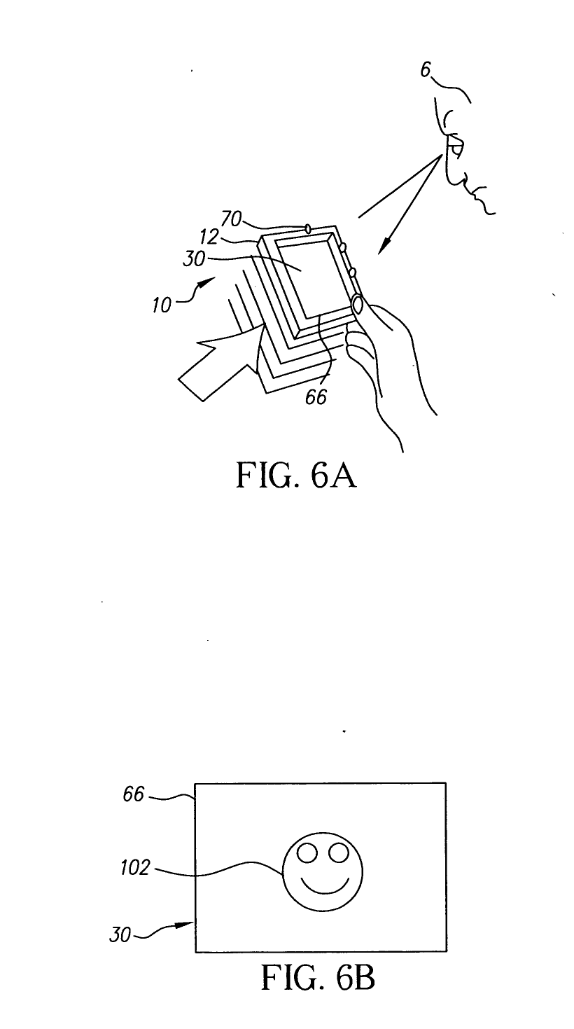

There are a variety of ways in which an image capture setting can be determined based on a change in viewing distance. FIGS. 5A, 5B, 6A and 6B illustrate one possible arrangement.

As shown in FIG. 5A, when user 6 moves digital camera 12 to increase the viewing distance between user 6 and viewing frame 66 as compared to the initial viewing distance of FIGS. 4A and 4B, user rangefinder 70 detects this change and provides controller 32 and/or signal processor 26 with signals from which the extent of the change in viewing distance can be determined (step 90). Controller 32 and/or signal processor 26 can sense such signals and can cause an adjustment of a setting to occur in response thereto (step 92). In this embodiment, when user 6 increases the viewing distance by moving display 30 further away from user 6, controller 32 increases the zoom magnification setting of camera 12. This can be done by changing the settings of any adjustable optical systems of image capture system 22 and/or by adjusting a digital zoom level. As a result, a zoomed-in evaluation image 100 of the scene is presented on display 30 as shown in FIG. 5B.

Similarly, as is illustrated in FIG. 6A, when user 6 decreases the viewing distance by moving viewing frame 66 closer to user 6, controller 32 decreases the zoom magnification of camera 12. This change in zoom magnification can be effected by adjusting optical characteristics of camera 12 or by adjusting a digital zoom level. As a result a zoomed-out or wide angle evaluation image 102 of the scene is presented on display 30 as shown in FIG. 6B.

In one embodiment, controller 32 causes adjustments to the zoom setting in relation to the change in viewing distance to be made. In other embodiments, signal processor 26 or other circuits and systems can cause zoom adjustments to be made. The relative extent to which the zoom level is adjusted based upon the change viewing distance can be preprogrammed or it can be manually set by user 6. This relation can be linear or it can follow other useful functional relationships including, but not limited to, logarithmic, and non-linear functions. Controller 32 can also consider other factors in determining the relative extent of the zoom adjustment to make in response to a detected change in the viewing distance. In one example, the relative extent of zoom adjustment per unit change in viewing distance can be established based upon a particular mode setting such as portrait of the so-called macro mode setting. Alternatively, the relative extent of zoom adjustment per unit change in viewing distance can be determined based upon a determined distance to a subject of a scene or so that when images or video are captured at relatively short distances such as when camera 12 is used, for example, in a macro, portrait, or close-up image capture mode from camera 12 only a modest change in the viewing position is necessary to effect a given degree of change in zoom magnification, while images that are captured at relatively long distance to the subject of a scene, such as for example, in a panoramic, or landscape mode a comparatively larger change in position can be necessary to effect a given degree of change in zoom magnification. Other factors including but not limited to the time rate of change in the viewing distance can also be considered by controller 32 in determining the distance that viewing frame 66 must be moved for controller 32 to cause a specific degree of adjustment in zoom settings.

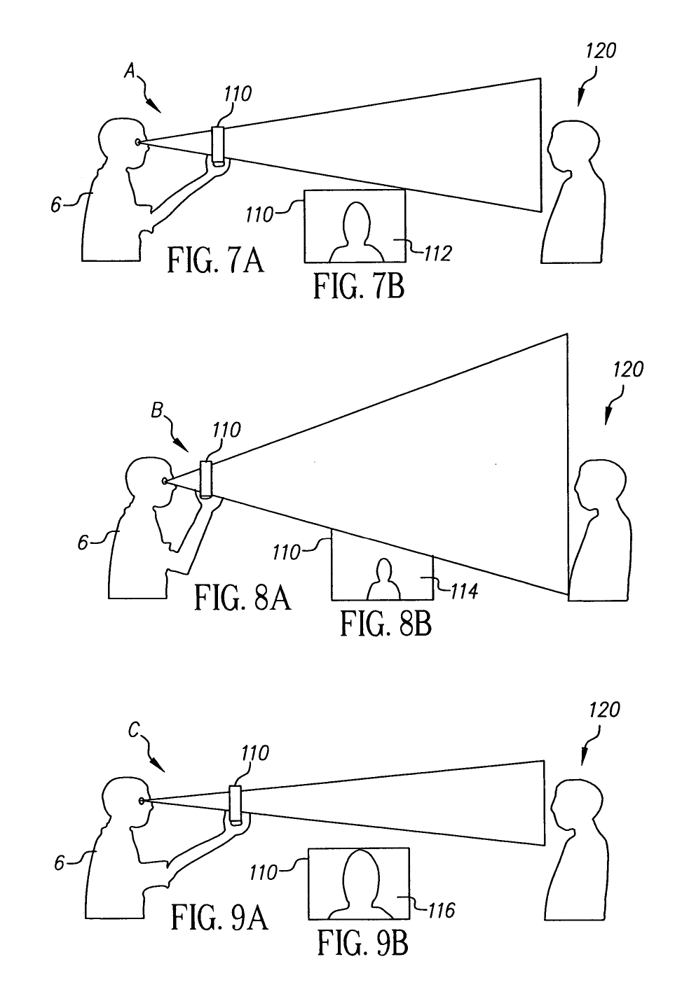

FIGS. 7A-7B-9A-9B illustrate one example of a way to determine the extent of variation in zoom settings based upon a detected change in viewing distance. In the embodiment of FIGS. 7A, 7B, 8A, 8B, 9A, 9B, the viewing frame comprises transmissive type viewing frame 110 having an image defining area through which user 6 observes a scene 120 during image composition. Transmissive type view frame 110 can comprise any type of device that separates light from a scene into an evaluation image portion and a non-evaluation image portion. In one embodiment, a transmissive type viewing frame 110 can comprise a mask. In other embodiments, a transmissive type viewing frame 110 can comprise at least one of an optical element, and an arrangement of optical elements, and the step of determining a revised setting further comprises determining a zoom setting based upon the optical characteristics of the optical element or arrangement of optical elements. In this embodiment, the step of determining an initial viewing distance (step 86) comprises determining the distance from viewing frame 110 to user 6 at a time such as the time that user 6 enters the composition mode. In the example of FIG. 7A, user 6 enters the composition mode when user 6 has viewing frame 110 located at position A. As shown in FIG. 7B, the initial evaluation image 112 of scene 120 is visible through transmissive type viewing frame 110 at the time that composition begins.

When as is shown in FIG. 8A, user 6 moves transmissive type viewing frame 110 to a position B that is farther from user 6, user 6 can observe, as shown in FIG. 8B, an evaluation image 114 of scene 120 containing a smaller portion of scene 120 than is visible when transmissive viewing frame 110 is located at the initial position A. Accordingly, controller 32 is adapted, in this embodiment, to establish a zoom setting so that camera 12 can obtain an image of scene 120 that conforms generally to image 114 seen through transmissive type viewing frame 110. As noted above, this can involve optical zoom adjustment and/or digital zoom adjustments.

When, as shown in FIG. 9A, user 6 moves transmissive viewing frame 110 to a position C that is closer to user 6, user 6 can observe, as shown in FIG. 9B, an evaluation image 116 of scene 120 containing a larger portion of scene 120 than is visible when transmissive viewing frame 110 is located at the initial position A. Accordingly, controller 32 is adapted, in this embodiment, to establish zoom setting so that camera 12 can obtain an image of the scene that conforms generally to evaluation image 116. As noted above, this can involve optical zoom adjustment and/or digital zoom adjustments.

Accordingly, when transmissive type viewing frame 110 is positioned more distantly from the user, camera 12 is prepared to capture an image that is magnified (telephoto) to an extent that is defined generally by what the user actually desires to include in the image. Similarly, when the transmissive type viewing frame 110 is positioned more closely to user 6, camera 12 is prepared to capture a wide angle view.

It will be noted that in FIGS. 7A, 7B, 8A, 8B, 9A and 9B user rangefinder 70 is not shown. However, it is present and active in all three of positions A, B, and C. User rangefinder 70 can take a variety of forms as noted above.

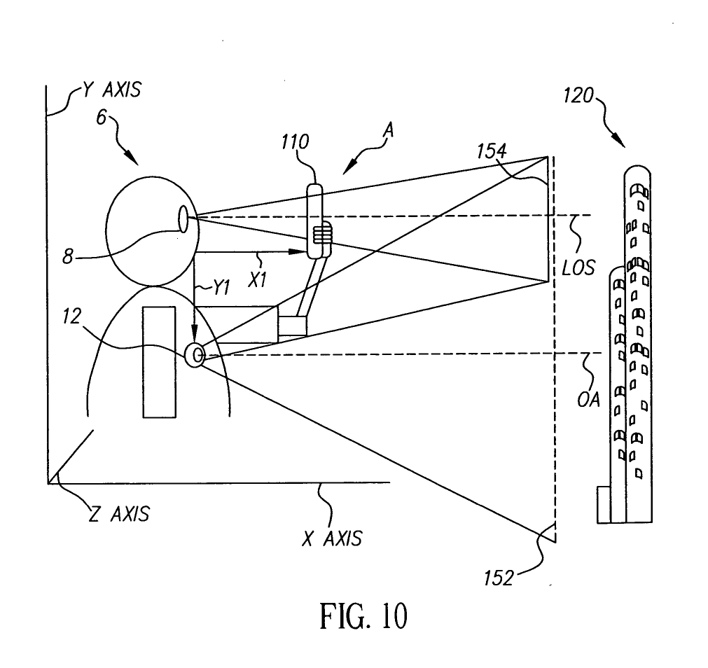

Either of a image generating type viewing frame 64 or a transmissive type viewing frame 110 can be fixed to digital camera 12 or as shown in FIG. 10 it can be separate therefrom. It will be appreciated that, when a transmissive type viewing frame 110 separated or separable from digital camera 12 then, image capture system 22 can be positioned at any of a variety of locations on the body of user 6, such as on a lapel, on a necklace, lanyard or armband, on a finger, such as a ring type embodiment, or any other location. However, parallax induced issues can occur in that the line of sight (LOS) from an eye 8 of user 6 through a transmissive type viewing frame 110 to the scene can be substantially different from the optical axis (OA) of the imaging system 22 of a digital camera 12. When this occurs, it is possible for camera 12 to capture an image of scene 120 that does not adequately correspond to the portion that is observable through viewing frame 110. This so-called parallax problem can create user dissatisfaction with captured images particular where there is a significant separation or deviation in the optical axes or where the subject image of the image is positioned relatively close to the digital camera 12.

A variety of well known approaches are known to compensate for conventional parallax problems that occur when a viewfinder system is provided having a different optical path that an image capture optical system. In one solution, lens driver 25 can be adapted to adjust the optical axis of lens system 23 and, if necessary, the zoom position of lens system 23 so that the field of view scene 120 provided by lens system 23 at image sensor 24 approximates the field of view observed by user 6 through viewing frame 110. In other solutions, when controller 32 determines that there is a separation between the optical axis of the of user 6 through viewing frame 110 and the optical axis of the lens system 23, controller 32 can cause lens driver 25 to widen the field of view of lens system 23 to an extent that encompasses at least a significant portion of the field of view of the scene that is observable to the viewer through the viewfinder. Controller 32 and/or signal processor 26 can cooperate to form an image based only upon signals from the portion of the image sensor that has received light from the portion of the scene that corresponds to the portion that is observable to user 6 via viewing frame 110, or at least the portion of the scene that is estimated to correspond to the portion that is observable to user 6 via viewing frame 110.

Alternatively, controller 32 and 6 or signal processor 26 can receive an image from image sensor 24 containing more than the portion of the image that corresponds to the portion that is visible through to user 6 through the viewfinder and can cause image to be formed by extracting the corresponding portion and, optionally, resampling the extracted portion. It will be appreciated, that in a typical imaging situation, the optical axis of the viewfinder system is fixed relative to the optical axis of the image capture system. This greatly simplifies the correction scheme that must be applied. However, there is a need for a system that can determine the field of view that is visible to a user 6 through a separate transmissive viewing frame at a moment of capture and to cause an image to be captured that reflects the field of view of an image capture system.

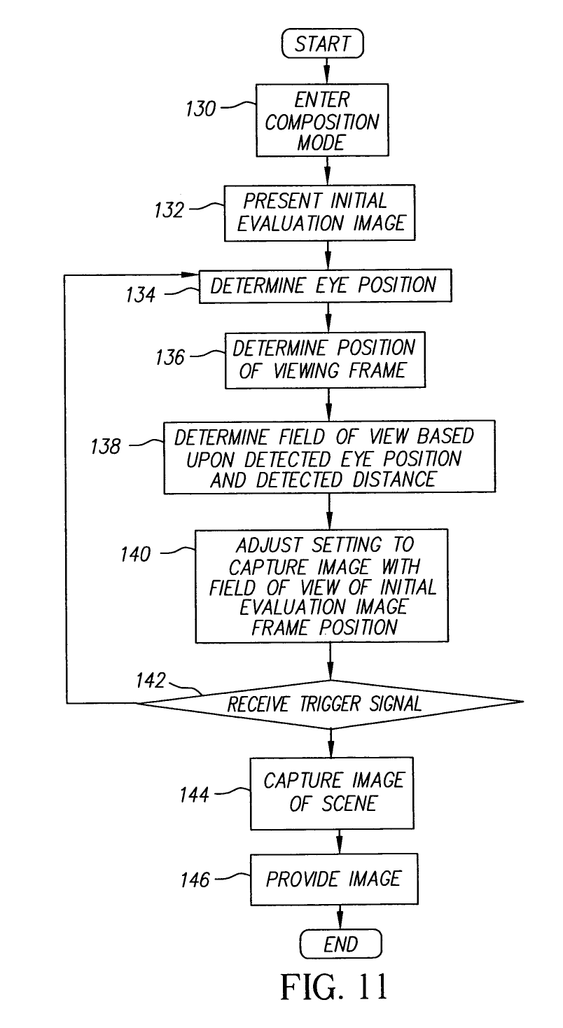

FIG. 11 is a flow diagram of a method for capturing an image that corresponds to the field of view of a user 6 through a transmissive type viewing frame. As is shown in FIG. 11, the determination of the field of view for use in capturing an image of the scene is based is based upon the relative position of transmissive viewing frame 110 and the position of the eyes 8 of user 6.

In accordance with the method, a user 6 directs digital camera 12 to enter composition mode (step 130). An initial evaluation image is then observable using transmissive viewing frame 110 (step 132) and an initial position of the eyes 8 of user 6 is determined (step 134). This can be done in a variety of ways.

In one embodiment, the position of the eyes 8 of user 6 are determined based upon a fixed relationship between the eyes 8 and the camera image capture system 22. For example as shown in FIG., 10, user 6 is shown wearing body 20 containing image capture system 22 of camera 12. In this embodiment, there is a generally consistent X and Y axis relationship between the position of eyes 8 and the position of the image capture system 22. Accordingly, in this embodiment, the relationship between image capture system 22 and eyes 8 of user 6 can be preprogrammed or customized by a user 6. Alternatively, a user image capture system 72 can be provided in camera housing 20 or with viewing frame 110 to capture images of the user 6 from which the position of the eyes 8 of user 6 relative to image capture system 22 or to viewing frame 110 can be determined. In the latter alternative, viewing frame 110 can provide user images for analysis by signal processor 26 and/or controller 32 by way of a wired or wireless connection.

An initial position of viewing frame 110 is then determined (step 134). In this embodiment, the initial position of viewing frame 110 is determined based upon the positional relationship between image capture system 22 and transmissive viewing frame 110. This can be done in a variety of ways. In one embodiment, image capture system 22 can be adapted to capture an evaluation image of a scene with a field of view that is wide enough to observe the relative position of the transmissive viewing frame 110 with respect to image capture system 22 and a distance from the eyes 8 of user 6 is determined based upon such an image. Alternatively, a multiple position rangefinder 27 can be calibrated so as to detect location of transmissive viewing frame 110 relative to camera 12. Such a multi-position rangefinder 27 can be adapted to have zones that are beyond the field of the maximum field of view of the image capture system 22 and arranged to sense both an X axis and a Y axis distance to the transmissive viewing frame.

In still another embodiment, transmissive viewing frame 110 can be equipped with a source of an electromagnetic, sonic, or light signal that can be sensed by a sensor 36 in camera 12 such as a radio frequency, sonic or light receiving system that can determine signal strength and a vector direction from image capture system 22 to transmissive viewing frame 110 in a manner that allows for the computation of X axis and Y-axis distances for use in determining an initial position of transmissive viewing frame 110.

Camera settings are adjusted based upon the relative positions of the viewing frame and eyes of the user so that an image captured by the image capture system 22 has a field of view that generally corresponds to the field of view of the evaluation image (step 140). If no trigger signal is detected (step 142), the method returns to step 134. If the trigger signal is detected, an image is captured (step 144) and an image that corresponds to the image viewed through transmissive type viewing frame 100 is provided (step 146). In one embodiment, the adjustments made to settings are made in a manner which causes the image as captured by digital camera 12 to have an appearance that corresponds to the appearance of the viewfinder. In another embodiment, the captured image is modified in accordance with the settings to more closely correspond to the field of view of the evaluation image.

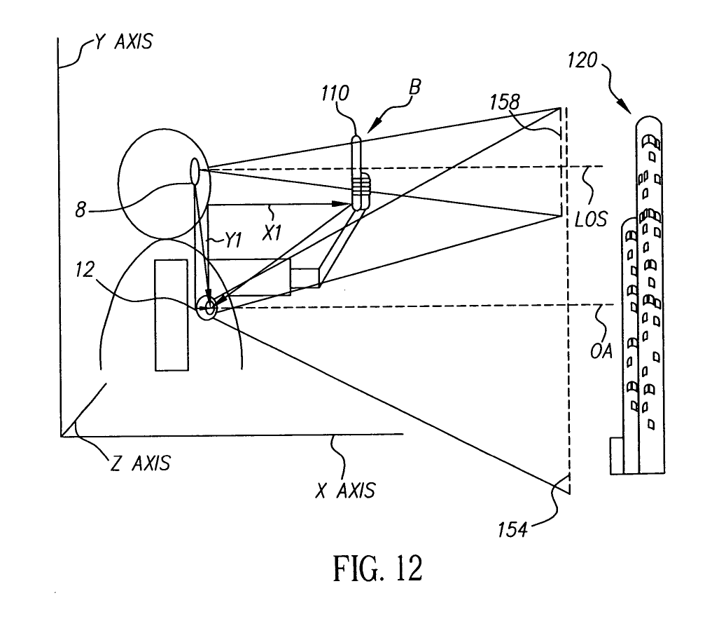

FIGS. 10 and 12 illustrate the process for determination of field of view for use in the captured image. As shown in FIG. 10, when a separable transmissive viewing frame 110 is placed in an in initial position A at coordinates X1, Y1 relative to the imaging system 22 in housing 12, while imaging system 22 is preprogrammed to assume that it is located at position X2, Y2 relative to eye 8 of user 6. As can also be seen in FIG. 10, housing 12 is positioned so that imaging system 22 can capture a field of view 152 of scene 120 including the field of view 154 of an initial evaluation image that is visible to user 6 through a framing area 156 of separable transmissive viewing frame 110.

FIG. 12 illustrates the processing for determining a field of view when viewing frame 110 is positioned to define image capture parameters for a telephoto image. When separable viewing frame 110 is moved from the initial X1, Y1 position shown in FIG. 10, to X2, Y2 shown in FIG. 12, the portion of scene 120 that user 6 can observe through framing area 156 defines a revised field of view that is smaller than the initial field of view 154 defines a telephoto field of view 158 for the capture of an image of scene 120. Accordingly, controller 32 adjusts camera zoom settings so that the field of view of a captured image generally corresponds to the field of view 158. In this embodiment, this is done by capturing an image of field of view 158 and cropping the captured image to conform thereto. On the basis of detection of the position of viewing frame 110 relative to imaging system 22 and the eyes 8 of user 6, a field of view within the scene 120 is captured. This may be accomplished by saving a portion of an image captured of a larger area of scene 120, or by adjusting the zoom and direction of optics image capture system 22.

It will be appreciated that user 6 is capable of viewing scene 120 using a transmissive type viewing frame 110 along a variety of angular positions along the Y and Z axis shown in FIGS. 10 and 12, and that the field of view for capture can be adapted to reflect this. Accordingly, in one embodiment, a transmissive type viewing frame 110 provides a view of scene 120 that is observable by the user within range of viewing angles and the step of adjusting a camera setting (step 140) comprises determining a viewing angle of the user relative to transmissive type viewing frame 110 and determining a viewing distance from the viewing frame to at least one of a head, eye, body and face of user 6 and a determined size of viewing distance and the size of a transmissive type viewing frame 110.

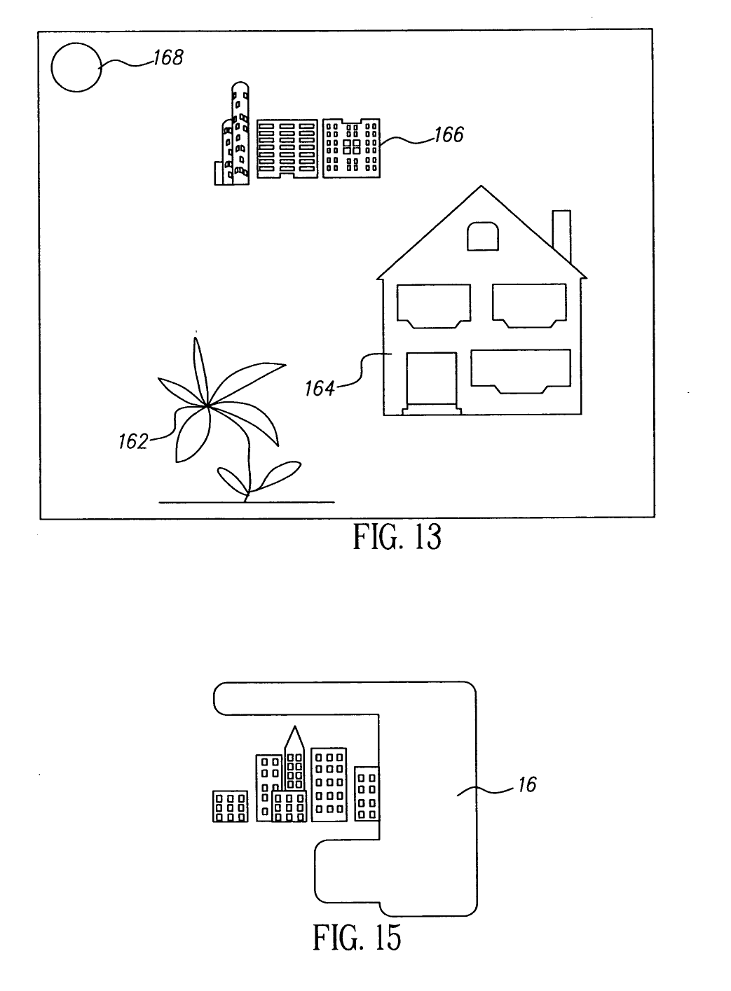

It will also be appreciated that the methods of the invention can be used for a variety of other purposes and to set a number of other camera settings. For example, the methods described herein can be used to help select from between a variety of potential focus distances when automatic focus is used to capture an image or to set camera flash intensity settings. FIG. 13 illustrates one way in which this can be done. As is illustrated in FIG. 13, when an automatic focus system is activated, the initial evaluation image or other evaluation images can be divided into different focus distances, shown here as a macro 162, near 164, far 166 and infinity 168. In one embodiment of the invention, user 6 can decide between these focus distances by associating one of the focus distances as an initial focus position that is associated with an initial viewing distance and then adjusting the viewing distance to discriminate between focus distances.

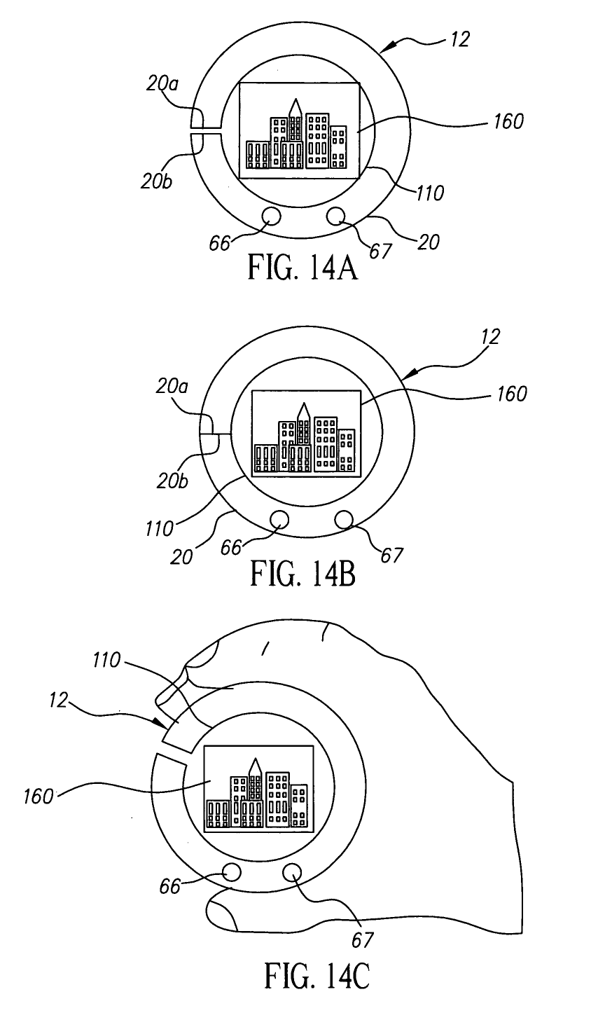

FIG. 14A, 14B and 14C illustrate example embodiments of one form of camera useful in the present invention.

FIG. 14A illustrates a simple and easy to use digital camera 12 according to one embodiment of the invention. In the embodiment that is illustrated, digital camera 12 has a transmissive type viewing frame 110 comprising a transmissive display 160 that provides an area that allows image composition, review and sharing while simultaneously allowing user 6 to view the scene. Transmissive display 160 can be a transparent or translucent display allowing user 6 to view a scene therethrough and to preset images and information. This enables spontaneous interaction by utilizing a dual mode transparent viewfinder (or display) capable of “freezing” an image it is aimed at. Digital camera 12 is configured for minimum complexity (compared to traditional cameras) and ease of image taking even during a simultaneous chat with friends.

The embodiment shown in FIG. 14A, 14B, and 14C has no conventional capture button or viewfinder. To compose an image, the user frames the scene using transmissive display 160. As is shown in FIG. 14B a user simply and naturally “squeezes” the circular body 20 of camera 12 so that contact point 20a and contact point 20b move into a more proximate position, such as a touching position shown in FIG. 14B. When this occurs, controller 34 causes an image to be captured. The captured image can then be presented as a “frozen” image on the transmissive display 160.

One embodiment of such a display 160 that is transparent and then appears to freeze the image as desired is to provide a transparent OLED panel as the display. The OLED panel is manufactured with transistors that are fabricated with substantially transparent materials. Thus the display is transparent in the composition mode when the display is off, and then becomes emissive after capture of an image. An active diffuser such as LCD privacy glass may be provided behind the OLED panel so that the effect of the background is minimized when the OLED is displaying the captured image. The diffuser is off and transmissive when in composition mode, but becomes opaque when turned on in display mode.

This embodiment and others described herein help to meet a need experienced by many amateur photographers to be able to capture an image while still being able experience an event or moment exactly as seen with one's eyes—without the interference of hardware control selections, viewfinder, screen navigation, etc., (what you see is what you get). The captured image may be instantly shared with others either by looking at it on the display or by looking at its transmitted copy on other displays

FIG. 15 illustrates another embodiment of a viewing frame 8 comprising a hand 16 of user 6. In this case, a digital camera 12 takes the form of a ring. In composition mode, evaluation images are available by viewing through a field of view framed by the hand 16 of user 6. The field of view is determined as that roughly outlined by the user's hand 16 in a particular position. Ring camera 12 can define the field of view by determining the distance from its position and the eyes of the user and zooms accordingly. The effect of using a hand 16 as a viewing frame is that of “grabbing” an image when the user determines that it is time to capture an image. The capture may be triggered by voice command or by detecting a hand gesture.

The position of the viewing frame relative to the eyes 8 of user 6 can be determined in any of a number of ways. When user 6 triggers capture, the distance and position of hand 16 relative to the eyes 8 of a user 6 is used to determine the zoom setting and/or the field of view. In one embodiment, there is no zoom setting due to the lack of zoom optics in the hand. In this case only the angular relationship of hand 16 to the eyes 8 of user 6 is important, not the distance. The field of view is fixed, and the position of the hand is used only to determine what portion of the surroundings of the user is to be captured. In another embodiment, an image of a large area is captured and digitally zoomed to correspond more closely to the field of view defined by hand 16 as viewed by user 6.

A more complex embodiment adds the step of determining the distance from the hand 16 to the eyes and uses this distance to determine zoom setting. The farther the hand is from the eyes, the higher the magnification used.

There may need to be a calibration step provided for good correlation between the viewing area defined by a hand 16 and portion of the scene that is captured by the camera. In calibration, a known target such as that shown in FIG. 16 is placed at a known distance from the user. In this case the target is placed on the wall at eye height at a distance of one meter. User 6 frames the center of the target by forming a viewing area with their hand 16. User speaks the command “Calibrate”, and the camera captures an image of the target. Camera 12 analyzes the captured image and determines calibration information that can be used to ensure that images are captured that reflect what the user sees in the viewing area center of the target. The calibration information can be used to control mechanical repositioning the direction of capture within the camera, or to define a subset of the entire image captured can be presented that corresponds to the desired area of capture. The calibration process can also be used to build a correspondence between camera settings and viewing distance on an individual basis.

A camera that can cooperate with a transmissive type based viewing frame can be placed on a necklace such as shown in FIGS. 10 and 12B, or it can be on other positions on the body, such as clipped above the ear or worn as a necklace or lapel pin. In this case, the camera must determine the distance and relative position from the camera to the hand to determine field of view, and can do so, as described above, by capturing an image that includes the hand or by otherwise sensing the distance to the hand using a rangefinder. Additionally, all the necessary electronics for capture and storage need not be located at one particular location on the body. So that the specific embodiments may be realized with multiple components located at a variety of places on a body of a user 6. Such components can cooperate, for example, by way of wired or wireless communication paths.

The invention has been described in detail with particular reference to certain preferred embodiments thereof, but it will be understood that variations and modifications can be effected within the spirit and scope of the invention.

### Parts List

6 user
10 image capture system
12 digital camera
16 hand of user
20 body
22 image capture system
23 lens system
24 image sensor
25 lens driver
26 signal processor
27 rangefinder
28 display driver
30 display
32 controller
34 input system
36 sensors
38 viewfinder system
40 memory
46 memory card slot
48 removable memory
50 memory interface
52 remote memory system
54 communication module
60 trigger button
64 mode selector button
66 display type viewing frame
68 edit button
70 user rangefinder
72 user imager
80 enter image composition mode step
82 present initial evaluation image step
84 determine the initial feeling distance step
86 capture button depressed determining step
88 exit composition mode determining step
90 detect change in viewing distance step
92 adjust setting of image capture device step
94 capture image step
96 initial evaluation image
100 zoomed-in evaluation image
102 wide angle evaluation image
110 transmissive type viewing frame
112 initial evaluation image
114 evaluation image
116 evaluation image
118 evaluation image
120 scene
130 enter composition mode step
132 define observable evaluation image
134 determine viewing distance
140 adjust camera setting step
142 trigger signal determining step
144 image capture step
146 provide image that corresponds to evaluation image step
154 field of view of initial evaluation image
156 frame area
158 field of view captured
160 transmissive display
162 macro scene elements
164 near scene element
166 far scene elements
168 infinity scene elements A viewing position B viewing position C viewing position

1. A method for operating an imaging system capable of forming images based upon adjustable image capture settings and a viewing frame in which evaluation images are observable; the method comprising the steps of:
detecting an initial viewing distance from the viewing frame to an anatomical feature of the user;
determining an initial image capture setting; and
detecting a change in the viewing distance, determining a revised image capture setting based upon the initial image capture setting and the extent of the change in the change in the viewing distance, and adjusting the image capture setting based upon the revised image capture setting.

2. The method of claim 1, wherein the viewing frame comprises a structure that separates light from a scene into an evaluation image portion and non-evaluation image portion.

3. The method of claim 1, wherein the viewing frame comprises an electronic display that is capable of presenting images that are viewed within a presentation space relative to the display and wherein the step of detecting a distance comprises detecting a viewing distance from the viewing frame to an object located within the range of viewing positions.

4. The method of claim 1, wherein the steps of detecting an initial viewing distance comprises projecting light into an area extending behind the viewing frame, receiving portions of the reflected light, and determining an initial viewing distance based upon the reflected light.

5. The method of claim 1, wherein the step of detecting an initial viewing distance comprises capturing an image of the part of the user and analyzing the image to determine a distance from the user.

6. The method of claim 5, wherein the distance is determined based upon at least one of the relative size of a head of the user, the spacing of eyes of the user, and the size of facial features of the user.

7. The method of claim 1, wherein the step of detecting a change in viewing distance comprises using a rangefinder to locate the user and determining a distance to the face of the user.

8. The method of claim 1, further comprising the step of calibrating the image capture device to establish a correlation between a range of distances from the viewing frame to the part of the user and a range of settings for image capture.

9. The method of claim 1, wherein the image capture setting comprises a flash intensity setting of a flash unit associated with the image capture device.

10. The method of claim 1, wherein the image capture setting comprises a zoom setting for optical or digital zoom.

11. The method of claim 1, wherein the image capture setting comprises a focus distance.

12. The method of claim 1, further comprising the step of setting an audio setting based upon the distance from the part of the user to the viewing frame.

13. The method of claim 1, wherein the viewing frame is at least one of an optical element, and an arrangement of optical elements, and wherein the step of determining a revised setting further comprises determining a zoom setting based upon the optical characteristics of the optical element or arrangement of optical elements.

14. The method of claim 1, wherein the viewing frame comprises a video display and said display is adapted to present evaluation images based upon the captured images, said evaluation images providing an indication of a field of view for image capture.

15. The method of claim 1, wherein the viewing frame is remote from the image capture device and the viewing frame communicates with a controller device to provide information from which the distance from the imaging surface to the feature of the body of the user can be determined.

16. The method of claim 1, wherein the viewing distance is determined by use of a sonic rangefinder.

17. The method of claim 1, wherein the viewing frame comprises a hand of the user.

18. A method for operating an image capture system having an image capture device, the method comprising the steps of:
determining a field of view in a scene based upon a portion of a scene that is observable by a user who views the scene using a viewing frame that is positioned separately from the image capture device;
determining at least one image capture setting based upon the determined field of view; and
capturing an image using the determined image capture setting and providing an image of the field of view.

19. The method of claim 18, wherein the step of determining a field of view comprises determining a viewing distance from the viewing frame to at least one of a head, eye, face and body of an observer and determining the field of view in the scene based upon the size of the framing area and the viewing distance.

20. The method of claim 18, wherein the viewing frame provides a view of the scene that is observable by the user within range of viewing angles and wherein the step of determining a field of view comprises determining a viewing angle of the user relative to the viewing frame and determining a viewing distance from the viewing frame to at least one of a head, eye, body and face of an observer and wherein the step of determining a field of view comprises in the scene further comprises determining the capture area based upon the determined viewing angle and determined viewing distance and the size of the viewing frame.

21. The method of claim 18, further comprising the step of setting a light emission intensity setting of an illumination source associated with the image capture device based upon the viewing distance.

22. The method of claim 18, further comprising the step of setting an audio zoom position based upon the viewing distance.

23. The method of claim 1, wherein the image capture setting comprises a zoom setting for optical or digital zoom.

24. The method of claim 1, wherein the image capture setting comprises a focus distance.

25. The method of claim 18, wherein the image capture setting comprises a focus distance.

26. An image capture system comprising:
an image capture circuit adapted to receive light and to form an image based upon the received light;
a viewing frame allowing a user of the image capture system to view an image of the scene and to define a field of view in the scene based upon what the user views using the viewing frame and a sensor system sampling a viewing area behind the viewing frame and providing a positioning signal indicative of a distance from the viewing frame to a part of the user's body; and
a controller adapted to determine an image capture setting based upon the positioning signal, to cause an image of the scene to be captured and to cause an output image to be generated that is based upon the determined setting.

27. The image capture device of claim 26, further comprising an optical system a having at least one adjustable optical element for focusing light from a scene onto the image capture device, wherein the determined image capture setting comprises a setting for adjusting the optical element.

28. The image capture device of claim 26, further comprising a signal processor adapted to modify the image of the scene to generate an output image that has an effective zoom magnification that is determined based upon the determined zoom setting.

29. An image capture device comprising:
an image capture system adapted to receive light and to form an image based upon the received light;
a viewing frame defining a field of view through which a user views a portion of the scene;
a viewing frame position determining circuit adapted to detect the position of the viewing frame;
an eye position determining circuit adapted to detect the position of an eye; and
a controller adapted to a provide an image based upon an image captured by the image capture system, the position of the viewing frame and the position of an eye of the user,
so that the image corresponds to the portion of the scene that is within the field of view as observed by the eye of the user.

30. The image capture system of claim 29, further comprising a flexible body having a capture contact area, normally biased into an open position, and contact sensors adapted to detect when the capture contact area of the body is urged against the bias into the closed position, said controller being adapted to cause an image to be captured in response thereto.

31. The image capture system of claim 29, wherein the controller causes an optical system on the image capture device to zoom to the capture area of the scene, causes an image including the field of view of the scene to be captured and an output image to be provided based upon the field of view.

32. The image capture system of claim 29, wherein the controller cause the image capture system to capture an image of the scene that contains more than the field of view and wherein said controller modifies the captured image so that the provided image has image information that corresponds to the field of view.

33. The image capture system of claim 29, wherein the controller is adapted to modify the captured image by cropping the captured image.

34. The image capture system of claim 32, wherein the controller is further adapted to resample the cropped image.

35. The image capture system of claim 29, wherein the viewing frame determining system comprises an image capture system adapted to detect an image of the viewing frame.

36. The image capture system of claim 29, wherein the viewing frame detector comprises an image sensor adapted to detect a position of a hand of a user forming a predefined shape.

37. The imaging system of claim 29, wherein the viewing frame detector comprises an image sensor adapted to detect a size of a framing area in the viewing frame.

38. The apparatus of claim 29, wherein the eye position determining system comprises a memory having information therein indicating that relative position of the user's eye with respect to the image capture system.

39. The apparatus of claim 29, wherein the eye position determining system detects at least one eye of the user, determines the direction of gaze of at least one eye, and determines a field of view based upon the direction of the gaze of at least one eye.

40. The apparatus of claim 29, wherein the viewing frame has a framing area comprising at least one of:
a display element being substantially transparent in a first state and emissive in a second state; and
a light attenuating element that is substantially transparent in a first state and substantially opaque in a second state, so that the user can observe the scene through the display and can also view images using the display.

41. An image capture device comprising:
a body having an image capture means for capturing an image of a scene in accordance with at least one image capture setting;
a viewing frame for allowing a user to observe a sequence of images depicting a portion of a scene during image composition;
a means for determining a viewing distance from the viewing frame to the user;
a means for determining at least one image capture setting based upon any detected change in the viewing distance during image composition; and
a setting means for setting the image capture system in accordance with the determined image capture setting.

42. The image capture device of claim 41, wherein the means for determining a viewing distance comprises:
a means for determining a position of an eye relating to a viewing frame; and
a means for determining a viewing distance based upon the determined positions.
